(19) United States
(12) Patent Application Publication
(10) Pub. No.: US 2010/0308240 A1
(43) Pub. Date: Dec. 9, 2010

(54) ELECTRIC FAIL SAFE VALVE ACTUATOR

(76) Inventors: Timothy K. McAdoo, Grand Prairie, TX (US); Richard Zeinert, Carrollton, TX (US)

Correspondence Address: BOOTH ALBANESI SCHROEDER LLC, 1601 ELM STREET, SUITE 1950, DALLAS, TX, 75201-4744, US

(21) Appl. No.: 12/772,908

(22) Filed: May 3, 2010

Related U.S. Application Data
(60) Provisional application No. 61/175,037, filed on May 3, 2009.

(51) Int. Cl. F16K 31/04

(52) U.S. Cl. 251/129.01

(57) ABSTRACT

A method and assembly are disclosed having a motor assembly, gear box assembly, clutch assembly, drive assembly and shaft operable to move between an extended and retracted positions. The shaft may be connected to operate a separate valve assembly. The gear box assembly is operably connected to and driven by the motor assembly. The gear box assembly drives the electromagnetically operated clutch assembly. The clutch assembly contains a fail-safe mechanism, thus providing a fail-safe mechanism downstream of the motor and gear box assemblies. Electric power is supplied to the clutch assembly to maintain the fail-safe mechanism in an engaged position. When electric power fails to be supplied to the clutch assembly, the fail-safe mechanism moves to the disengaged position. A compressible mechanism drives the shaft to its other position when the fail-safe mechanism disengages. The shaft is moved to its other position without driving the motor and gear box assemblies and irrespective of whether those assemblies are operable. The drive assembly may be reversible, powering the shaft to both positions. The drive assembly is a ball screw assembly in an exemplary embodiment.

### CROSS REFERENCE TO RELATED APPLICATIONS

This application claims priority from the U.S. Provisional Application Ser. No. 61/175,037, filed May 3, 2009, by Timothy McAdoo and Richard Zeinert, both of Texas, entitled “ELECTRIC FAIL SAFE VALVE ACTUATOR,” which is hereby incorporated in its entirety for all purposes.

### FIELD OF THE INVENTION

The invention relates generally to electrically powered fail safe valve actuators for use with valves in which the valve member is moved between open and closed positions by reciprocation. More particularly, the invention relates to improvements in fail safe actuators for reciprocating valves which utilizes a spring-loaded ball screw assembly with the fail safe mechanism comprising an electromagnetic clutch such as are typically used in the oil and gas industry.

### BACKGROUND OF THE INVENTION

Incorporated herein by reference for all purposes are the following publications: U.S. Pat. No. 6,488,260 to Dietz “Electric Fail Safe Valve Actuator,” U.S. Pat. No. 5,195,721 to Akkerman entitled “Fail Safe Valve Actuator,” U.S. Pat. No. 5,518,462 to Yach entitled “Spring Return Electric Actuator,” U.S. Pat. No. 5,865,272 to Wiggins entitled “Differential Drive Linear Actuator,” U.S. Pat. No. 5,915,668 to Hodapp entitled “Fail Safe Valve Actuator,” U.S. Pat. No. 5,984,260 to Rawson entitled “Electrically Driven Actuator with Failsafe Feature,” U.S. Pat. No. 6,585,228 to McCaskill entitled “Electric Valve Actuator with Eddy Current Clutch,” and ME90 Product Data Sheet “Model ME90 Fail-Safe Actuator,” copyright Cooper Cameron Corporation (2004).

### BRIEF DESCRIPTION OF THE DRAWINGS

FIG. 1 is a cross-sectional elevational view of an electric fail safe valve actuator embodying the invention; and

FIG. 2 is an orthogonal view of the actuator of one embodiment of the invention.

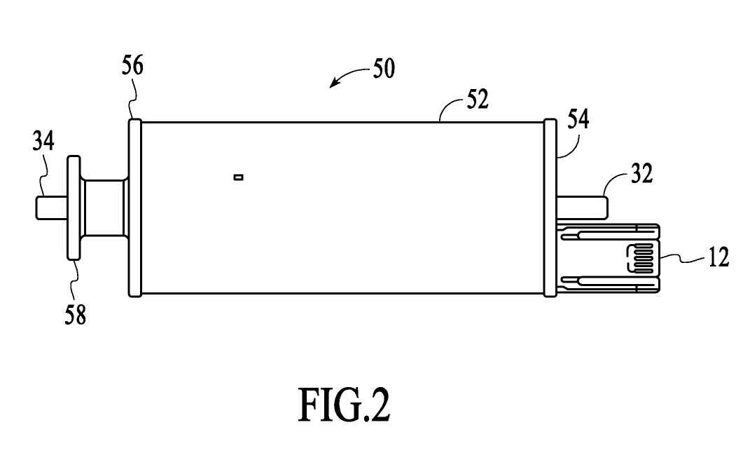

The Figures are provided, with end views, side views and top/bottom views, some in cross-section or with parts removed or shown in dashed lines or light shade to provide views of parts otherwise obscured. A practitioner will recognize that these drawings, even without lengthy textual explanation, provide the information necessary to make and practice the invention without undue experimentation and exhibit the inventor had in his possession at the time of filing of the application the invention.

The use of terms indicating orientation of the device, such as top, bottom, side, up, down, and upstream or downstream, are not intended to limit the orientation of the device in practice but are used to expedite discussion and understanding of the device.

### DETAILED DESCRIPTION OF A PREFERRED EMBODIMENT

This invention relates to a valve actuator that is operated to selectively open and close a valve. More particularly, the actuator moves a valve closure member in a gate, ball, or other type of valve between open and closed positions and thereby controls flow through the valve. The actuator is envisioned primarily for use as an emergency fail safe valve actuator such as for use on surface safety valves, a shutdown valve, a blow down valve, and the like. The actuator is used in emergency situations to quickly close the valve by tripping a release means that allows a coiled spring to rapidly move the valve closure member from a first, typically open, position to a second, typically closed, position. Valve actuators are required to be able to open the valve and hold the valve open against the full working pressure of the valve. This internal valve pressure may exert a substantial force against the actuator, trying to overcome the opening force generated by the actuator. Simultaneously, the actuator must be able to react in an emergency situation and close the valve in a matter of seconds.

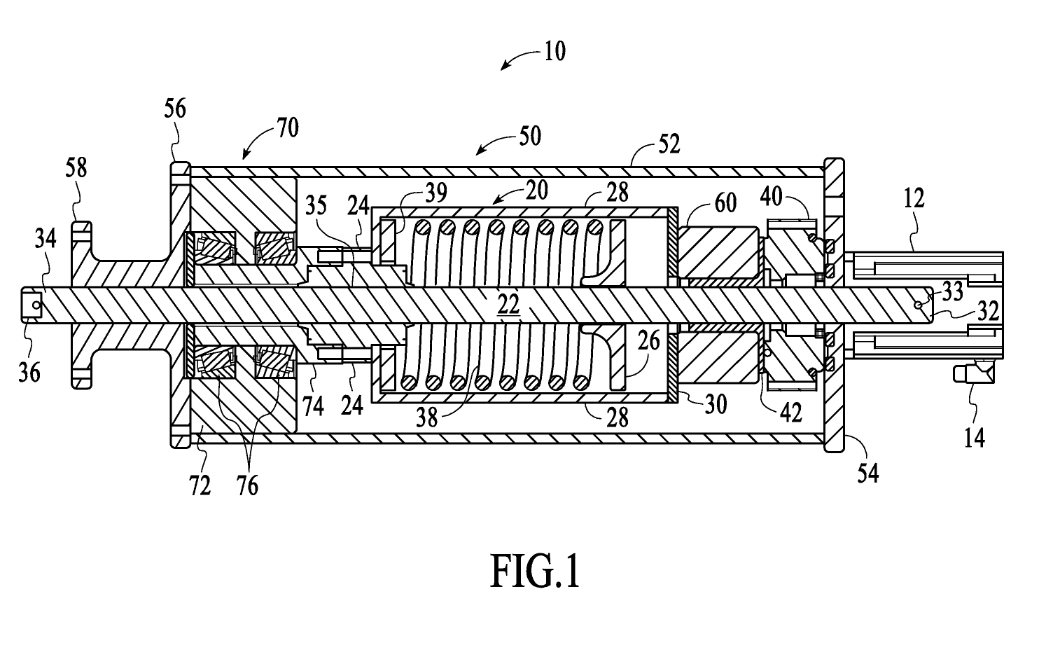

FIG. 1 is a cross-sectional elevational view of a preferred embodiment of the invention. Generally depicted is fail safe valve actuator 10. The actuator 10 is powered by an electric motor 12 as shown, although it is known in the art to use other powering mechanisms, such as hydraulic and pneumatic power. Motor 12 is shown as off-set with the ball screw assembly 20, ball screw shaft 22, gearbox assembly 40 and clutch assembly 60, in FIG. 1. An in-line motor 12 can be provided, such as a DDR, Direct Drive Rotary motor, for example. In the preferred embodiment, the motor 12 is electrically powered and power cable connectors 14 are provided.

The motor 12 is operably connected to operate a ball screw assembly 20 which includes a ball screw shaft 22, ball screw nut 24, collar 26, torque tube 28, and torque tube adapter 30.

The motor 12 is operably connected to a gearbox assembly 40. The gearbox assembly 40 is preferably a cycloidal gearbox, as shown, although other types of gear boxes are known in the art and may be employed. The motor is offset axially from the shaft 22. In the view seen in FIG. 1, the motor 12 is behind the input end 32 of the ball screw shaft 22. An off-set motor allows the ball screw assembly 20 to be more easily accessed for repair and maintenance and allows direct access to the input end 32 of the ball screw shaft 22.

The ball screw assembly is housed, primarily, in a casing assembly 50. The casing assembly 50 includes a preferably tubular housing 52, a top cap 54 and a bottom cap 56. The parts of the casing assembly are bolted together but can be connected together in any manner known in the art. The casing assembly 50 preferably includes a valve adapter bracket or flange 58. The flange may take many forms known in the art and is selected of a design to allow connection of the actuator valve assembly 10 to the valve assembly it is to operate. Shown is a flange 58 having bolt holes for bolting the actuator assembly 10 to a valve assembly (not shown). Other arrangements will be apparent to the practitioner. Top cap 54 is provided with holes, fittings and seals as needed to allow extension of assembly parts through the top cap and connection of parts on either side of the top cap. For example, the shaft 22 extends through the top cap and the motor and gearbox are connected from either side of the top cap.

The motor 12 is preferably positioned outside the main casing assembly 50 for ease of access and operation. The motor 12 is operably connected to the gearbox assembly 40. The gearbox is preferably a cycloidal gearbox. Such a gearbox is rugged, provides low to zero backlash, is compact and highly efficient. The motor 12 is connected to the gearbox by a direct, shaft-to-gear connection. In a preferred embodiment, the output shaft of the motor is directly connected to the input side of gearbox. Other designs, such as gear to gear, or chain and sprocket can be employed for transmission of torque from the motor to the gearbox.

The gearbox assembly 40 is operably connected to the clutch assembly 60. The output side of the gearbox is connected to the input side of the clutch assembly. In one embodiment, the output shaft of the gearbox assembly is connected by a key to a hollow shaft on the input side of the clutch assembly. Other arrangements can be envisioned, such as a gear to gear connection, etc. A hollow bore connector 42 is interposed between the gearbox assembly 40 and clutch assembly 60. The hollow bore connector allows the shaft 22 to extend through it and the hollow bores of the gearbox assembly 60 and clutch assembly 40.

In the preferred embodiment, the clutch assembly 60 is an electromagnetic toothed clutch assembly. Portions of the clutch assembly 60, including a clutch, rotate in response to rotation of the output side of the gearbox assembly 40. The clutch assembly 60 is a direct drive unit operably connected to the ball screw assembly 20 to operate the assembly 20. The direct drive of the clutch is such that one turn of the clutch results in one turn of whatever it is connected to (the adapter 30, as shown, or the ball screw nut 24, for example). The output end of the clutch assembly is connected to the adapter 30 of the ball screw assembly 20. For example, an output flange of the clutch assembly can be bolted or otherwise fixedly connected to the adapter 30. The clutch of the clutch assembly 60 has a toothed rotatable clutch plate on the input side which engages a corresponding toothed clutch plate on the output side. The toothed plates engage one another when electric power is supplied to the electromagnetic clutch assembly. Electric power actuates a magnet which forces the clutch into engagement. The clutch offers positive driving force regardless of ball screw shaft 22 loading. This is important given the heavy loading typical on ball screw shafts 22 in fail safe valve actuators.

Further, this allows a compact arrangement for a smaller total dimension of the actuator 10, the casing assembly 20, and allows for most of the actuator elements to be inside the casing assembly 50. The preferred embodiment is approximately 47″ long, including the input end of the shaft 32, motor 12 and valve adapter flange 58. The design allows an in-line fully enclosed unit; all of the driving mechanisms are inside the casing assembly 50, not mounted as modular units to the outside of the casing assembly. The width of the preferred embodiment is approximately 15″ and does not have modular units or assemblies extending further outward, such as a limit switch or other mechanisms. This compactness is provided by the design of the invention. This small envelope or footprint is provided by these advancements and, for example, by using a hollow bore gear box and clutch mounted inside the actuator 10. The dimensions here can vary, however the design of the actuator 10 is such as to be more compact than the prior art.

Electric power is supplied to the electromagnetic clutch assembly 60 continuously to engage the clutch and maintain driving engagement between the clutch and the ball screw assembly 20. If power is cut to the electromagnetic clutch, whether by design or in an emergency, the clutch 60 disengages (the toothed clutch plates separate) and the ball screw assembly 20 is free to rotate without rotating the input side of the clutch assembly 60. This is the location of the “fail safe mechanism” of the fail safe valve actuator 10; the electromagnetically operated clutch. The fail safe actuator 10 will actuate and close the valve if electric power to the electromagnetic clutch is ever cut or lost. The loss of electric power to the clutch assembly will result in the toothed clutch disengaging. The actuator 10 will operate even if the motor 12 or gearbox 40 are jammed, frozen, or otherwise inoperable, and regardless of the operability of the connections between the motor 12, gearbox assembly 40 and clutch assembly 60.

Prior art assemblies, which have other differences in operation as well, provide the “fail safe mechanism”, such as a solenoid, etc., at locations further “upstream” of the operable assembly, such as ball screw assembly 20. For example, some prior art actuators position the fail safe mechanism (e.g., solenoid) between the motor and gearbox, or between the gearbox and clutch. Thus, when the emergency condition occurs requiring closing of the valve, the actuator responds by having to operate (e.g., rotate) not only the ball screw assembly but also the clutch, gearbox and/or motor. Damage or inoperability of any of these parts reduces or eliminates the effectiveness of the actuator, slowing down or preventing its operation. Further, in these prior art devices, the operation of the coil spring in closing the valve (driving the closing of the valve by quickly and forcefully moving the shaft 22 and rotating the ball screw nut 24, torque tube 28, etc.), which requires operation or movement by the clutch, gears of the gearbox, and/or the motor itself, increases the likelihood that these parts, placed under such great torque, force, and speed, may be damaged during the emergency closing of the valve. This might result in ineffectiveness of the actuator during the closing operation or damage to the parts requiring repair or replacement after use.

The ball screw assembly 20 includes an input end 32, preferably provided with a connector 33 such as a ⅜″ hole. The output end 34 of the shaft 22 has a connector 36 for connecting the shaft to the valve apparatus to be opened and closed by the actuator. The shaft 22 extends through the casing assembly 50 which is provided with holes, fittings, seals and bearings as needed. The shaft 22 is, at least in part, a helically threaded screw which engages a similar groove on the interior surface of the ball screw nut 24. As the nut 24 is turned, the ball screw shaft 22 extends or retracts (and vice versa). Threaded portion 35 of the shaft 22 must be of sufficient length to provide for engagement with the nut 24 over the travel of the shaft 22 in operation. A torque tube 28 is provided which transmit torque from the clutch assembly 60 to the ball screw nut 24. In an alternate arrangement, the clutch assembly can transmit torque to the shaft 22. The torque tube houses a coil spring 38 which engages a slip ring 39 at one end and a ball screw collar 26 at the other end. The ball screw collar 26 is attached to the ball screw shaft 22 such that as the shaft 22 moves axially (extends or retracts), the collar 26 also moves. The relative motion of the collar 26 with respect to the slip ring 39 and torque tube 28 acts to compress or decompress the coil spring 38 as the collar 26 moves axially.

The coil spring 38 in one embodiment provides 6000 pounds of force, when compressed, and preferably over its 4″ length of travel. A preferred coil is approximately 16″ in length when unloaded.

Although the actuator is shown to be a ball nut and helically grooved screw, this invention contemplates that other low friction, reversible drives may be used including those, for example, having other helically grooved nuts which receive helically grooved screws but in which elements other than balls are in rolling engagement with the grooves. Also, the screw shaft may be supported for rotation in the body and the nut connected to the valve to be operated.

Thrust bearing assemblies 70 are also provided, including thrust bearing cage and bottom base plate 72, ball screw to thrust bearing bracket 74, thrust bearings 76, and thrust bearing retainer plate 78. Thrust bearing assemblies are interposed between the ball screw assembly 20 and the main base plate 56. Multiple thrust bearings 76 can be used and are housed in cage 72. A thrust bearing bracket 74 or similar is positioned between the thrust bearing cage 72 and ball screw nut 24. Thrust bearing retainer plate 78 is positioned at the lower end of the thrust bearing assembly 70. The thrust bearing assembly 70 is positioned on the main base plate 56 of the casing assembly 50.

In operation, the fail safe valve actuator is attached to operate a valve, such as a gate valve, in a pipeline or other use. The flange 58 is connected to the valve assembly (not shown). The output end 34 of the shaft 22 is connected by connector 36 to the valve stem or other selected portion of the valve. Axial movement, extension and retraction of the shaft 22, operates to open and close the valve. It is understood that the actuator and valve can be connected such that either extension or retraction of the shaft opens the valve. In the preferred embodiment, the shaft 22 operates to open the valve when the shaft is extended. The shaft 22 operates to close the valve when retracted.

To open the valve, for normal use of the pipeline, the electric motor 12 is operated to drive the cycloidal gearbox assembly 40. The gearbox assembly 40 drives the electromagnetic clutch assembly 60. Electric power is supplied to the electromagnetic clutch assembly 60. The electric power thus provided places and maintains the clutch in engagement. The output side of the clutch assembly is connected to the adapter 30. The clutch is a direct drive, one-to-one, mechanism. The adapter 30 is fixedly connected to the torque tube 28, which in turn is fixedly connected to the ball screw nut 24. Rotation of the adapter 30 by the clutch, therefore, also rotates the nut 24. The nut 24 is movably connected to the shaft 22, such as by corresponding thread and groove, and rotation of the nut 24 results in axial movement of the shaft 22. During opening of the valve, the nut 24 operates to extend the shaft 22 and output end 34 of the shaft thereby opening the valve. As the shaft 22 is extended axially, the collar 26, which is fixedly attached to the shaft 22 also moves axially. The collar engages the top end of the coil spring 38 and compresses it against the slip ring 39 as the shaft is extended. The coil spring is preferably fully compressed. The actuator 10 remains in this position during normal operation and use of the pipeline.

The clutch assembly 60 can engage and rotate the ball screw nut 24, directly or indirectly, as shown. Alternately, the clutch assembly 60 can engage and rotate the ball screw shaft 22 directly or indirectly. The toothed clutch assembly 60 operably connects to the clutch-to-torque tube adapter 30. The teeth of one of the clutch plates engages and interfaces with corresponding teeth on the adapter 30. As the clutch rotates in response to rotation of the gears of the gearbox 40, the clutch-to-torque tube adapter 30 rotates. The adapter 30 is connected fixedly to the torque tube 28. The torque tube 28 is fixedly attached to the ball screw nut 24 of the ball screw assembly 20. As the clutch turns, the ball screw nut is also turned. In turn, the ball screw shaft 22 which extends through the ball screw nut 24 extends or retracts axially. Operation of ball screw assemblies and variations in design are known in the art.

To close the valve, the shaft 22 is retracted. This may be accomplished in a controlled manner such as by operating the motor in reverse. However, the actuator is designed for emergency use and immediate closing of the valve. The valve can be closed by interruption of electric power to the electromagnetic clutch assembly 60. The power can be manually switched off by a user or cut by accident and the actuator 10 will operate to close the valve.

When power is cut to the electromagnetic clutch assembly 60, the toothed clutch plates disengage. The output end of the clutch is now free to rotate. Similarly, the ball screw assembly 20, to which the output end of the clutch is connected, is free to rotate. The compressed coil spring 38 then unloads, driving the ball screw assembly 20. The coil spring 38 unloads, decompressing and pressing against collar 26. The collar is moved axially away from the slip ring 39. As the collar 26 moves, the shaft 22 also moves, retracting from its open position to its closed position. Movement of the shaft 22 results in rotational movement of the ball screw nut 24 and torque tube 28, adapter 30 and output portion of the clutch assembly 60. Since the fail safe mechanism (the disengagement of the clutch from the adapter) is downstream from the input end of the clutch, the input portions of the clutch, the gearbox, and the motor, none of those parts are rotated or operated when the power is cut to the clutch assembly.

While the preferred embodiment of the invention has been disclosed with reference to particular cutting enhancements, and methods of operation thereof, it is to be understood that many changes in detail may be made as a matter of engineering choice without departing from the spirit and scope of the invention.

1. A fail-safe valve actuator comprising:
a motor assembly;
a gear box assembly operably connected to the motor assembly, the gear box assembly driven by the motor;
an electromagnetically operated clutch assembly connected to the gear box assembly, the clutch assembly driven by the gear box assembly, the clutch assembly containing a fail-safe mechanism, the fail-safe mechanism movable between an engaged and a disengaged position, wherein electric power is supplied to the clutch assembly to maintain the fail-safe mechanism in the engaged position and wherein when electric power fails to be supplied to the clutch assembly, the fail-safe mechanism moves to the disengaged position;
a drive assembly driven by the clutch assembly, the drive assembly for moving a shaft to one of a retracted or an extended position;
a compressible mechanism for driving the shaft to its other position; and
the shaft operable to be connected to a valve assembly for opening and closing the valve assembly.

2. An actuator as in claim 1 wherein the drive assembly is reversible and is operable to drive the shaft to both the retracted and extended positions.

3. An actuator as in claim 1 wherein the drive assembly is a ball screw assembly.

4. An actuator as in claim 1 wherein the compressible mechanism is a coil spring.

5. An actuator as in claim 1 wherein, when the clutch assembly is in the disengaged position, the compressible mechanism drives the shaft to its other position but does not drive the gear box assembly or the motor assembly.

6. An actuator as in claim 5 wherein the shaft is movable in response to the compressible mechanism when the clutch assembly is in the disengaged position, even if the motor assembly or gear box assembly is inoperable.

7. An actuator as in claim 5 wherein the clutch assembly is a toothed, electromagnetic clutch assembly having two cooperating toothed clutch plates, the two plates in contact with one another when the clutch assembly is in the engaged position and the two plates spaced apart when the clutch assembly is in the disengaged position.

8. An actuator as in claim 1 wherein the motor assembly is off-set from the shaft.

9. An actuator as in claim 3 wherein the ball screw assembly includes a ball screw nut which cooperates with a helical groove extending along at least a portion of the shaft.

10. An actuator as in claim 9 wherein the ball screw nut is driven by the clutch assembly and wherein driving of the ball screw nut operates to move the shaft towards its extended or retracted position.

11. An actuator as in claim 10 wherein the ball screw assembly further comprises a torque tube and wherein torque is transmitted to the ball screw nut by the torque tube.

12. An actuator as in claim 11 wherein the torque ball screw assembly further includes a collar attached to the shaft, the collar moving with the shaft as the shaft moves between its extended and retracted positions.

13. An actuator as in claim 12 wherein the compressible mechanism is a compression coil spring, and wherein the coil spring engages the collar at one end and a slip ring at the other end.

14. An actuator as in claim 1 wherein the clutch assembly is a direct-drive, one-to-one clutch assembly.

15. An actuator as in claim 11 wherein the clutch assembly is a toothed, electromagnetic clutch assembly having two cooperating toothed clutch plates, the two plates in contact with one another when the clutch assembly is in the engaged position and the two plates spaced apart when the clutch assembly is in the disengaged position, and wherein one of the toothed clutch plates is a torque tube adaptor fixedly connected to the torque tube.

16. A method for actuating a valve utilizing a fail-safe valve actuator, the method comprising the steps of:
operably connecting an electromagnetic clutch assembly between a gear box assembly and a drive assembly, the drive assembly for moving a shaft between an extended and a retracted position, the shaft for operating the valve;
driving the shaft to one of the extended or retracted positions utilizing a motor connected to the gear box assembly;
providing electric power to an electromagnetic clutch assembly, the electric power maintaining the clutch assembly in an engaged position;
cutting the electric power to the electromagnetic clutch assembly, the electromagnetic clutch assembly moving to a disengaged position in response to the cutting of electric power; and
driving the shaft to the other of its positions using a compressible mechanism after cutting the electric power to the electromagnetic clutch assembly, thereby closing the valve.
